(19) United States
(12) Patent Application Publication
(10) Pub. No.: US 2011/0249252 A1
(43) Pub. Date: Oct. 13, 2011

(54) FIBER OPTIC SECURITY MAT SYSTEM

(75) Inventors: Joel Lantz, Bedford Heights, OH (US); Michael McNeilly, Gilbert, AZ (US)

(73) Assignee: Cleveland Electric Laboratories, Twinsburg, OH (US)

(21) Appl. No.: 13/046,466

(22) Filed: Mar. 11, 2011

Related U.S. Application Data
(60) Provisional application No. 61/312,909, filed on Mar. 11, 2010.

(51) Int. Cl. G01B 11/16; B23P 11/00

(52) U.S. Cl. 356/32; 29/428

(57) ABSTRACT

A sensing device includes a first layer, a second layer, and an optical sensor. The first layer includes a first surface for supporting an associated load. The first layer transmits a strain to a second surface due to the associated load located on the first surface. The second layer is formed of a compliant material and provides substantially uniform support to the first layer and deflects due to the associated load. The optical sensor is positioned between the first and second layers and senses the strain due to the associated load.

### CROSS-REFERENCE TO RELATED APPLICATIONS

This application claims the benefit of U.S. Provisional Application No. 61/312,909, titled FIBER OPTIC SECURITY MAT SYSTEM, filed Mar. 11, 2010, which is herein incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

This invention relates generally to security monitoring and particularly with regard to detecting the undesired, unlawful, or hazardous presence of persons, objects, or vehicles.

2. Description of Related Art

The present art includes various technologies that detect or attempt to detect the undesired, unlawful, or hazardous presence of persons, objects, or vehicles. Such detection has become especially necessary with the recent increase in international terrorism, which has included planting of bombs in subway and railway stations. Presently available intrusion detection methods include: the interruption of photo-electrically-detected light beams, radar, ultrasonic and infrared motion-sensing devices, video-camera monitoring, including automatic detection techniques and software, pressure sensors attached to tubing, pressure-activated switches, piezoelectric sensors, and piezoelectric film.

Additionally, recent security monitoring approaches have utilized or attempted to utilize fiber-optic methods and devices that detect changes in the strain of an attached fiber-optic sensor when an undesired object or person impinges on or against a fence or mat. However, the fiber optic security mat devices with which the inventors are familiar have not worked well, having only spotty detection capability, They are therefore insufficiently sensitive over the surface of the mat to avoid false negatives, thereby missing the presence of an offending object or person in some areas of the mat.

Therefore, what is needed is a fiber-optic security mat system that has distributed sensitivity over the surface of the mat and therefore can reliably detect the presence of persons, objects, or vehicles over the entire mat without false negatives. The characteristics of this system should include the ability to discriminate between objects or persons of potential concern and objects that have too small a mass to be objects of concern. What is also needed is a system that can closely estimate the position of the detected persons, objects, or vehicles and as well track the speed and direction of travel.

### BRIEF SUMMARY OF THE INVENTION

According to one embodiment of this invention, a sensing device includes: a first layer including a first surface for supporting an associated load, wherein the first layer transmits a strain to a second surface due to the associated load location on the first surface; a second layer formed of a compliant material, wherein the second layer provides substantially uniform support to the first layer and deflects due to the associated load; and an optical sensor positioned between the first and second layers, wherein the optical sensor senses the strain due to the associated load. The first layer can include a polymer membrane, a metallic membrane, or a composite membrane. The second layer can be formed of a closed cell elastomer, a plastic sponge, a closed cell foam, a soft rubber, a gel-filled rubber or plastic envelope, or an elastomeric composite. The second layer can include a bottom surface that resists sliding. The first layer can include a top layer and a first middle layer. The top layer can include the first surface and can be formed of a wear-resistant material. The separate first middle layer can include the second surface and can be formed of a material having sufficient modulus to transmit strains from the associated load to the optical sensor. The top layer can be formed of a plastic mat. The second layer can include a second middle layer and bottom layer. The second middle layer can be formed of the compliant material which deflects due to the associated load. The separate bottom layer can provide protection to the other layers. In some embodiments, when the edges of the first layer and the second layer are sealed together to encapsulate the optical sensor and prevent ingress of contaminants, the sensing device can further include one or more sections of microporous hydrophobic membrane connected to the volume between the sealed layers so as to facilitate venting of air pressure between the layers due to thermal expansion. The optical sensor can include an optical fiber having at least one fiber Bragg grating operatively connected to an associated fiber Bragg grating signal processing system. The optical sensor can include an optical fiber operatively connected to an associated distributed sensing signal processing system.

According to another embodiment, a sensing device includes: a first layer including a top surface for supporting an associated load, the top surface formed of a flexible and wear-resistant material; a second layer including a membrane with sufficient modulus to transmit strains from the associated load to an optical sensor operatively connected to the second layer; and a third layer formed of a compliant material having a resilience which allows the second layer to flex and recover due to the associated load; wherein an outside edge of the third layer is operatively attached to an outside edge of the first layer substantially encapsulating the second layer, and wherein the second layer is able to move relative to the first and third layers. The sensing device can further include a microporous hydrophobic membrane operatively connected to the volume between the layers which facilitates venting of the air between the layers due to thermal expansion. The second layer can include a frictional coating on surfaces adjacent the first and third layers. The sensing device can further include an additional layer positioned between the first and second layers, wherein the additional layer is formed of a compliant material which deflects due to the associated load. The sensing device can further include an additional layer positioned beneath the third layer to provide protection to the upper layers. The optical sensor can include an optical fiber including at least one fiber Bragg grating operatively connected to an associated fiber Bragg grating signal processing system. The optical sensor can include an optical fiber operatively connected to an associated distributed sensing signal processing system.

According to another embodiment, a method of assembling a strain sensing device includes the steps of: attaching an optical fiber to a middle layer so that any strain created by an associated load and experienced by the first layer is transmitted to the optical fiber; attaching a top layer to a bottom layer along an outside edge substantially encapsulating the first layer between the second and third layers; and connecting the optical fiber to an associated signal processing system for measuring the strain created by the associated load. The method can further include the steps of evacuation of at least a portion of any volume between the layers to minimize any air between the layers and thereby preventing ballooning effects from thermal expansion of the air. The method can further includes the steps of evacuating the air located between the top and bottom layers before substantially sealing the middle layer between the top and bottom layers. The method can further includes the steps of applying a frictional coating between the top and middle layers and between the middle and bottom layers before substantially sealing the middle layer between the top and bottom layers. The method can further includes the steps of inserting an additional layer between the top and bottom layers before substantially sealing the additional and middle layers between the top and bottom layers.

One advantage of this invention is the ability of its combination of membrane strain sensor assembly and compliant layer below to transmit strain from any location to one or more strain-sensing fiber Bragg gratings or to a distributed-strain sensing optical fiber.

Another advantage of this invention is the ability of its combination of membrane strain sensor assembly and compliant layer below to estimate the position of the detected of persons, objects, or vehicles.

Another advantage of several of the embodiments of this invention is substantial independence of mat properties from sensing properties, thereby allowing the choice of mat materials to be optimized for other properties, such as resilience, fire safety, wear resistance, and pedestrian slip resistance.

Another advantage of this invention is the complete EMI immunity of fiber Bragg gratings and optical fibers.

Yet another advantage of this invention is the small size and ultimate simplicity of fiber Bragg gratings and optical fibers. For example, if single-mode fibers and gratings are used, buffered single-mode optical fibers and integral fiber Bragg gratings are only about 0.9 mm in diameter. Unbuffered single-mode optical fibers and integral fiber Bragg gratings are only 0.25 mm or less in diameter. These parts can be installed easily, inexpensively, and almost seamlessly into the assembled security mat sensing device, which is necessarily thin for practical purposes. This invention can include the use of multi-mode fibers.

Yet another advantage of this invention is the low cost of a multiplicity of fiber Bragg gratings on the same fiber when manufactured continuously on the single fiber as draw-tower gratings, which are well known in the art. A potentially even greater cost advantage is realized, at least with larger systems, when distributed sensing technology is used instead of fiber Bragg grating technology.

Yet another advantage of this invention is the ability of optical fibers to transmit signals over long distances (as far as several kilometers) with negligible loss.

Yet another advantage of this invention is the ability to incorporate and interrogate many sensors—or sensor regions in the case of distributed sensing technology—on a single optical fiber. This multiplexing ability greatly simplifies cabling and measurement instrumentation.

Yet another advantage of this invention is the corrosion resistance of optical fiber and fiber Bragg gratings. Unlike wired metallic sensors, the silica glass does not corrode under normal conditions (although excessive moisture can weaken it).

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 illustrates the construction of a fiber Bragg grating, according to one embodiment;

FIG. 2 illustrates the strain measurement principle for a fiber Bragg grating, according to one embodiment;

FIG. 3 is an illustration of distributed strain, according to one embodiment;

FIG. 4 depicts one or more strain-sensing fiber optic elements bonded to a strain-distributing membrane, which is supported by a compliant layer, according to one embodiment;

FIG. 5 shows different fastening approaches that a fiber Bragg grating and its integral fiber can be bonded to the underside of the strain-distributing membrane, according to some embodiments;

FIG. 6 illustrates a small number of the many possible patterns in which strain-sensing fiber Bragg gratings—or distributed fiber optic strain sensors—can be bonded to the strain-distributing membrane;

FIG. 7 shows a cross section of the security mat sensing device, according to one embodiment;

FIG. 8 shows a cross section of the security mat sensing device, according to one embodiment;

FIG. 9a shows a cross section of the security mat sensing device, according to one embodiment;

FIG. 9b shows a cross section of the security mat sensing device, according to one embodiment;

FIG. 10a shows a cross section of the security mat sensing device, according to one embodiment;

FIG. 10b shows a cross section of the security mat sensing device, according to one embodiment;

FIG. 11a shows a cross section of the security mat sensing device, according to one embodiment;

FIG. 11b shows a cross section of the security mat sensing device, according to one embodiment;

FIGS. 12a and 12b illustrate how distributed sensing—using distributed-sensor signal processing hardware and plain optical fiber as the sensing medium—can be interchangeably incorporated into all embodiments of the invention.

### DETAILED DESCRIPTION OF THE INVENTION

For convenience in reviewing the drawings, descriptions corresponding to the drawing reference numerals are listed below.

1 Fiber Bragg grating

2 Optical fiber

3 Beam

4 Bonding agent, such as adhesive

5 Simple supports for beam

6 Strain-distributing membrane

6a Combined strain-distributing membrane and mat layer

7 Compliant layer

8 Unbuffered coated optical fiber

9 Buffer layer on buffered optical fiber

10 Bonding agent, such as adhesive

11 Bonding agent, such as adhesive

12 Protective bottom layer

13 Mat layer

14 Bonding agent, such as adhesive

15 Upper compliant layer

16 Bonding agent, such as adhesive

17 Sealed edge

Applicant will now describe several embodiments of the present invention.

According to a first embodiment of this invention, the security mat sensing device of the security system can include the following five mutually bonded layers, listed from top to bottom:

The first layer can include an elastomeric or plastic mat, such as a mat designed to carry foot traffic, of sufficient durometer and thickness to resist puncture and wear, yet with sufficient flexibility to transmit load to the layers below.

The second layer can include an upper thin compliant layer of highly resilient material such as elastomer foam to substantially decouple mat properties from the adjacent strain sensor assembly and thereby transmit substantially vertical loads to the membrane strain sensor assembly below.

The third layer can include a membrane strain sensor assembly, which includes a plurality of unbuffered fiber Bragg gratings (FBGs), as well as their immediately adjacent short sections of fiber, bonded at strategic locations to the underside of a polymer, composite, or metallic membrane. The membrane is chosen to have sufficient modulus and thickness to transmit strains from incident loads anywhere on the mat to one or more of the fiber Bragg gratings so as to cause readily measurable shifts in characteristic reflected Bragg wavelengths of one or more fiber Bragg gratings. An example suitable polymer membrane material is polyethylene terephthalate (Mylar). An example suitable metallic membrane material is spring steel.

The fourth layer can include a second, lower compliant layer having a density, compressive modulus, resilience, and thickness that allows the membrane strain sensor assembly to flex and recover sufficiently to transmit strain to the fiber Bragg gratings. At the same time this compliant layer is supportive enough to prevent damage to the membrane strain sensor assembly when the mat layer is subjected to foreseeable overloads.

The fifth layer can include a lower layer that protects the upper layers from damage and provides a surface that resists sliding or can be bonded to a variety of substrates. This final layer can be made of a polymer, metal, or composite material.

In some embodiments, the security system may include signal processing hardware and software and/or firmware including: (1) one or more instruments or instrument combinations that can translate shifts of fiber Bragg grating characteristic Bragg wavelengths into data signals—devices and combinations that are well known in the fiber-optics art, (2) a signal processing device or devices, such as a computer, that, with suitable software, firmware, or both, can use data signals to record and analyze security mat events, (3) software and/or firmware for the signal processing device or devices that can analyze the fiber Bragg grating wavelength shifts and discriminate between the presence of innocuous and potentially adverse loads incident on the novel sensing device, trigger alarms and notifications, optionally determine the direction of travel of moving loads, optionally estimate the magnitude of loads, and optionally trigger other security events well known in the art, such as the focusing of video cameras to the locations where loads have been detected.

According to a second embodiment, the sensing device includes the mutually bonded five layers of the first embodiment, except that the top layer (the mat) and the bottom layer have slightly larger widths and lengths than the inner three layers, and the top layer and the bottom layer are sealed to each other at the edges. This sealing prevents ingress of dirt and moisture to the inner three layers, thereby increasing the reliability of the security mat sensing device.

According to a third embodiment, the sensing device includes the mutually bonded five layers of the first or second embodiment, except that the fiber Bragg gratings in the membrane strain sensor assembly are bonded only at their short adjacent sections of fiber adjacent to the gratings. The gratings themselves are not bonded to the membrane. This modification to the first embodiment is not essential and can be somewhat more difficult to manufacture. However, it ensures that bonding irregularities cannot cause unequal stretching of the Bragg reflection planes, which could result in broadening, shouldering, or splitting of the characteristic Bragg reflected wavelength peaks.

According to a fourth embodiment, the security mat sensing device includes the mutually bonded five layers of the first, second, or third embodiments, except that tight-buffered fiber Bragg gratings are bonded to the underside of the membrane strain sensor assembly instead of unbuffered fiber Bragg gratings. Buffered fiber Bragg gratings generally do not measure membrane strains quite as effectively as unbuffered gratings. However, the use of buffered fiber Bragg gratings can simplify manufacture of the device and potentially impart greater contamination resistance to the gratings.

According to a fifth embodiment, the sensing device includes the five layers of the first, second, third, or fourth embodiments. However, the five layers are bonded to each other only at selected areas, in regularly repeatable bonding agent patterns such as stripes or dots. Such selected bonding reduces the need for excessive application of bonding agent while retaining layer coherence and facilitating air removal from the layers.

According to a sixth embodiment, the sensing device includes the five layers of the first, second, third, fourth, or fifth embodiments. The added feature is the mechanical evacuation of air space between the layers in a manner similar to the evacuation of air space in a plastic food storage bag. The result is a minimum internal gas volume, which reduces the potential for ballooning of the security mat sensing device due thermal expansion of residual gas between the layers of the device, thereby resulting in a device that is more flat.

According to a seventh embodiment, the sensing device includes the five layers of the first, second, third, fourth, fifth, or sixth embodiments. This embodiment includes the added feature of venting the air space between the layers using a microporous hydrophobic membrane, such as a Gore-Tex membrane. Addition of such a venting membrane allows breathing of the device, thereby reducing the potential for a ballooning of the security mat sensing due to thermal expansion of residual gas between the layers of the device. The vent membrane's hydrophobic nature and fine pore size avoids the ingress of water, and its fine pore size avoids the ingress of dirt.

According to an eighth embodiment, the sensing device includes the five layers of the first, second, third, fourth, fifth, sixth, or seventh embodiments. However, in this embodiment, long lengths of fibers on both sides of the fiber Bragg gratings are bonded to the membrane. This extended bonding enhances adhesion of the fiber to the membrane and ensures the reliable transmission of strains to the gratings via a larger bond surface.

According to a ninth embodiment, the sensing device includes the layers 1, 2 3, and 5 of the first, second, third, fourth, fifth, sixth, seventh, or eighth embodiments. The fourth layer is eliminated, and the bottom compliant layer has a density, compressive modulus, resilience, and thickness that allows the membrane strain sensor assembly to flex and recover sufficiently to transmit strain to the fiber Bragg gratings. Additionally, this compliant layer is supportive enough to prevent damage to the membrane strain sensor assembly when the mat layer is subjected to foreseeable loads. The compliant layer is also strong enough to protect the upper layers from damage and provides a surface that resists sliding or can be bonded to a variety of substrates. In some embodiments, a soft elastomeric polymer, such as low durometer neoprene, would be appropriate for this bottom compliant layer.

According to a tenth embodiment, the security mat sensing device of the security system includes the following mutually bonded three layers, listed from top to bottom:

A first layer can include combination polymer-membrane and mat strain sensor assembly, which includes a plurality of buffered or unbuffered fiber Bragg gratings (FBGs), as well as their immediately adjacent short sections of fiber, bonded at strategic locations to the underside of a polymer sheet that functions both as a mat—such as a mat designed to carry foot traffic—and as a mechanical membrane. The combination membrane and mat has sufficient modulus and thickness to transmit strains from incident loads anywhere on its upper surface to one or more of the fiber Bragg gratings on its lower surface, so as to cause readily measurable shifts in fiber Bragg grating characteristic reflected Bragg wavelengths. However, the combination membrane and mat must not be so thin as to transmit strain inadequately and be damaged easily, and not so thick as to flex insufficiently. The geometry and composition of the combination polymer-membrane and mat part of this layer specifically meet the requirements of puncture and environmental-damage resistance, stable mechanical properties, rapidly-responding resilience, low hysteresis, and preferably low thermal coefficient of expansion to minimize thermally induced strains.

A second layer can include a compliant layer having a density, compressive modulus, resilience, and thickness that allows the polymer-membrane and mat strain sensor assembly to flex and recover sufficiently to transmit strain to the fiber Bragg gratings. Additionally, this compliant layer is supportive enough to prevent damage to the membrane strain sensor assembly when the mat layer is subjected to foreseeable loads.

A third layer can include a bottom layer that protects the upper layers from damage and provides a surface that resists sliding or can be bonded to a variety of substrates. This third layer can be made of a polymer, metal, or composite material.

According to an eleventh embodiment, the security mat sensing device of the security system includes the following mutually bonded two layers, listed from top to bottom:

The first layer can include the first layer, or combination polymer-membrane and mat strain sensor assembly, of the tenth embodiment; and

The second layer can include a bottom compliant layer having a density, compressive modulus, resilience, and thickness that allows the membrane strain sensor assembly to flex and recover sufficiently to transmit strain to the fiber Bragg gratings. Additionally, this compliant layer is supportive enough to prevent damage to the membrane strain sensor assembly when the mat layer is subjected to foreseeable loads. The compliant layer is also strong enough to protect the upper layers from damage and provides a surface that resists sliding or can be bonded to a variety of substrates. In some embodiments, a soft elastomeric polymer, such as low durometer neoprene, would be appropriate for this bottom layer.

According to a twelfth embodiment, the security mat sensing device of the security system includes the following three layers, listed from top to bottom:

The first layer can include an ordinary or standard elastomeric or plastic mat, such as a mat designed to carry foot traffic, of sufficient durometer and thickness to resist puncture and wear, yet with sufficient flexibility to transmit load to the layers below. This first layer is not bonded to a second layer. Instead, the first layer is slightly wider and longer than the second layer and is edge-bonded to a third layer so as to encapsulate the second layer.

The second layer can include a membrane strain sensor assembly, which includes a plurality of buffered or unbuffered fiber Bragg gratings (FBGs), as well as their immediately adjacent short sections of fiber, bonded at strategic locations to the underside of a polymer, composite, or metallic membrane. The membrane is chosen to have sufficient modulus and thickness to transmit strains from incident loads anywhere on the mat to one or more of the fiber Bragg gratings so as to cause readily measurable shifts in characteristic reflected Bragg wavelengths of one or more fiber Bragg gratings. An example suitable polymer membrane material is polyethylene terephthalate (Mylar). An example suitable metallic membrane material is spring steel. This second or middle layer is not bonded to the first and third layers at any location, except for fiber optic cables that connect the fiber Bragg gratings of the second layer to other system components. This lack of bonding to membrane strain sensor assembly decouples the membrane strain sensor assembly from the physical properties of the first and third layers, thereby minimizing the effects of differential thermal expansion, hysteresis, and shear debonding. It also reduces the hazards and costs of applying substantial quantities of bonding agents.

A third layer or bottom compliant layer has a density, compressive modulus, resilience, and thickness that allows the membrane strain sensor assembly to flex and recover sufficiently to transmit strain to the fiber Bragg gratings. Additionally, this compliant layer is supportive enough to prevent damage to the membrane strain sensor assembly when the mat layer is subjected to foreseeable loads. The compliant layer is also strong enough to protect the upper layers from damage and provides a surface that resists sliding on or can be bonded to a variety of substrates. In some embodiments, a soft elastomeric polymer, such as low durometer neoprene, would be appropriate for this bottom layer. This bottom layer is slightly wider and longer than the second layer and is edge-bonded to the first layer so as to encapsulate the second layer. This encapsulation prevents ingress of dirt and moisture to the inner three layers, thereby increasing the reliability of the security mat sensing device.

According to a thirteenth embodiment, the security mat sensing device is constructed as in the twelfth embodiment with the addition of the mechanical evacuation of air space between the layers in a manner similar to the evacuation of air space in a plastic food storage bag. The result is a minimum internal gas volume, which reduces the potential for ballooning of the security mat sensing device due to thermal expansion of residual gas between the layers of the device, thereby resulting in a more flat device.

According to a fourteenth embodiment, the security mat sensing device is constructed as in the twelfth embodiment with the addition of venting the air space between the layers with a microporous hydrophobic membrane, such as a Gore-Tex membrane. Addition of such a venting membrane allows breathing of the device, thereby reducing the potential for a ballooning of the security mat sensing device due to thermal expansion of residual gas between the layers of the device. The vent membrane's hydrophobic nature and fine pore size avoids the ingress of water, and its fine pore size avoids the ingress of dirt.

According to a fifteenth embodiment, the security mat sensing device is constructed as in the twelfth, thirteenth, or fourteenth embodiments with the addition of frictional coatings between the three layers. Frictional coatings—for example, rubbery anti-slip coatings such applied to the undersides of carpets—will inhibit movement between the layers, thereby inhibiting bulging or buckling of the mat layer and the assembly in general. The requirement is for frictional coatings to be applied between the mat layer and membrane strain sensor assembly, as well as between the membrane strain sensor assembly and the bottom layer. For the interface between the mat layer and the membrane strain sensor assembly, frictional coatings may be applied to either or both layers. For the interface between the membrane strain sensor assembly and the bottom layer, frictional coatings may be applied to either or both layers.

According to a sixteenth embodiment, which applies to all of the previously described embodiments, standard optical fiber—without fiber Bragg gratings—may be substituted for the fiber with Bragg grating. In the embodiments which use only an optical fiber, the signal is analyzed using distributed-sensor signal processing hardware and software and/or firmware. Distributed-sensor technology utilizes standard optical fiber as, effectively, a continuous, integral string of sensors. This approach potentially lowers system cost, at least in larger fiber optic security mat systems.

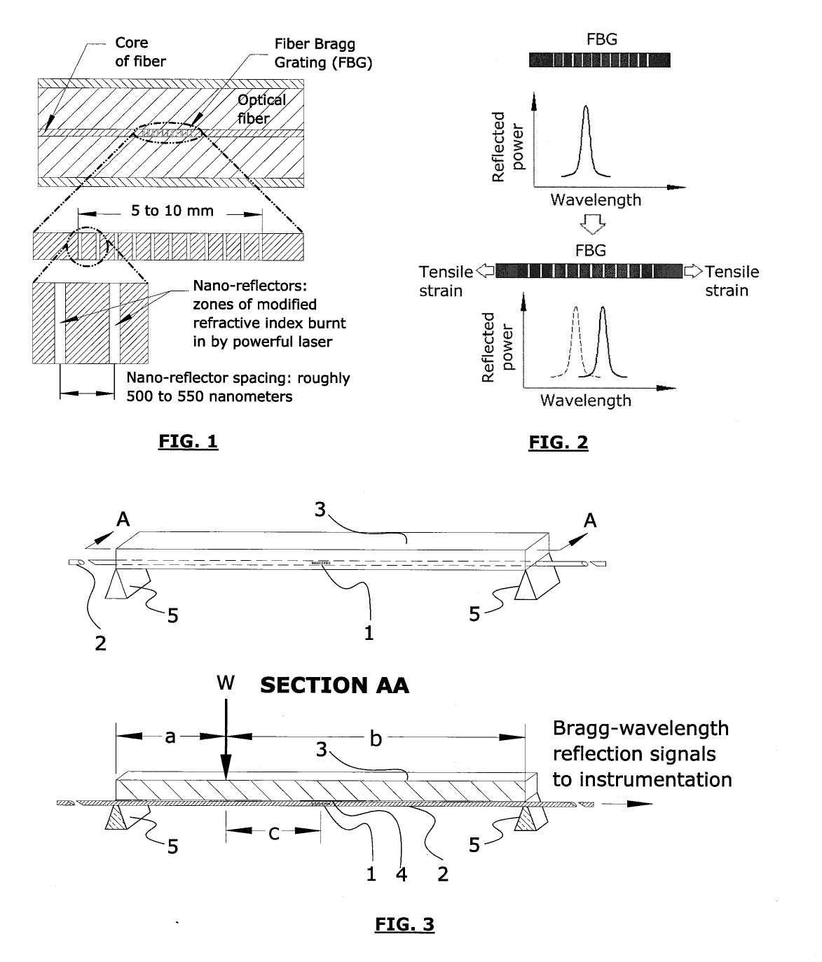

Referring now to the drawings wherein the showings are for purposes of illustrating embodiments of the invention only and not for purposes of limiting the same, and wherein like reference numerals are understood to refer to like components, FIG. 1 briefly illustrates the construction of a fiber Bragg grating 1, as is well known in the art. In some embodiments, fiber Bragg gratings 1 comprise the primary sensing elements of the present invention. In other embodiments, distributed optical sensors—optical fibers—comprise the primary sensing elements. The areas of modified refractive index in a fiber Bragg grating each back-reflect a tiny amount of light. When the back-reflected light from these nano-reflectors combines, it combines constructively when the half-wavelength of the reflected light equals the distance between the nano-reflectors—the so-called period of the nano-reflectors. With thousands of equally spaced nano-reflectors in the fiber Bragg grating reflecting this specific wavelength, called the Bragg wavelength or resonant wavelength, the combined constructive interference is substantial. When the reflections from the fiber Bragg grating are analyzed as function of wavelength, the Bragg wavelength reflections stand out as a peak—as will be clear in the next figure, FIG. 2. The reflections from the fiber Bragg grating can be analyzed as a function of wavelength using a variety of devices well known in the art, including scanning optical interrogators—for example, the sm-series and si-series of instruments manufactured by Micron Optics, Inc. of Atlanta, Ga.

FIG. 2 briefly illustrates the strain measurement principle for a fiber Bragg grating (FBG), also well known in the art. The upper part of this figure shows the Bragg-wavelength peak that stands out from the spectrum of analyzed wavelengths. The bottom part of this figure shows what happens when the fiber Bragg grating (FBG) is stretched by strain in the material to which it is attached. Stretching due to positive strain causes the spacing between the nano-reflectors (the period) to increase proportionally, thereby increasing the reflected peak wavelength proportionally. In contrast, compression of the fiber Bragg grating due to negative strain in the attached material conversely causes the spacing between the nano-reflectors (the period of the nano-reflectors) to decrease proportionally, thereby decreasing the reflected peak wavelength proportionally.

FIG. 3 shows how strain can be transmitted remotely to a fiber Bragg grating (FBG) that is bonded with bonding agent 4 to a simply supported beam 3 so that it stretches to the same extent that the beam stretches at that location and thereby reflects a shifted Bragg wavelength through optical fiber 2. Bonding agent 4 is typically an adhesive but may alternatively be another material, such as fused low-temperature solder glass. For illustration-of-principle purposes only, this combination of elements models a type of very narrow security mat sensing device. In this model, the weight W of a person, object, or vehicle on the beam at any location results in strain at the location of the fiber Bragg grating 1, stretching of fiber Bragg grating 1, and shifting of the measured Bragg-wavelength peak as described in FIG. 2. For this simple beam-and-strain-sensor model, well understood in the mechanical engineering and civil engineering art, it can easily be shown by one skilled in the art that a small-deflection strain s at fiber Bragg grating 1 relates to weight W as follows:

$$ɛ = - \frac{Wa ( b - c )}{EZ ( a + b )}$$

where E is the Young's modulus of the beam and Z is the section modulus of the beam.

With continuing reference to FIG. 3, note that the strain is maximum when c=0, or in other words, when weight W is directly above the fiber Bragg grating. However, substantial strain is still transmitted to the fiber Bragg grating at locations distant from the weight W. For example, if c=b/2, the strain seen by the fiber Bragg grating is still half of the maximum strain. The purpose of FIG. 3 is to illustrate distribution of strain over the entire beam. The presence of only a few microstrains are sufficiently detectable relative to the typically low background-noise of current model fiber Bragg grating signal processing instruments or instrument combinations, such as the Micron Optics, Inc. sm- and si-series instruments.

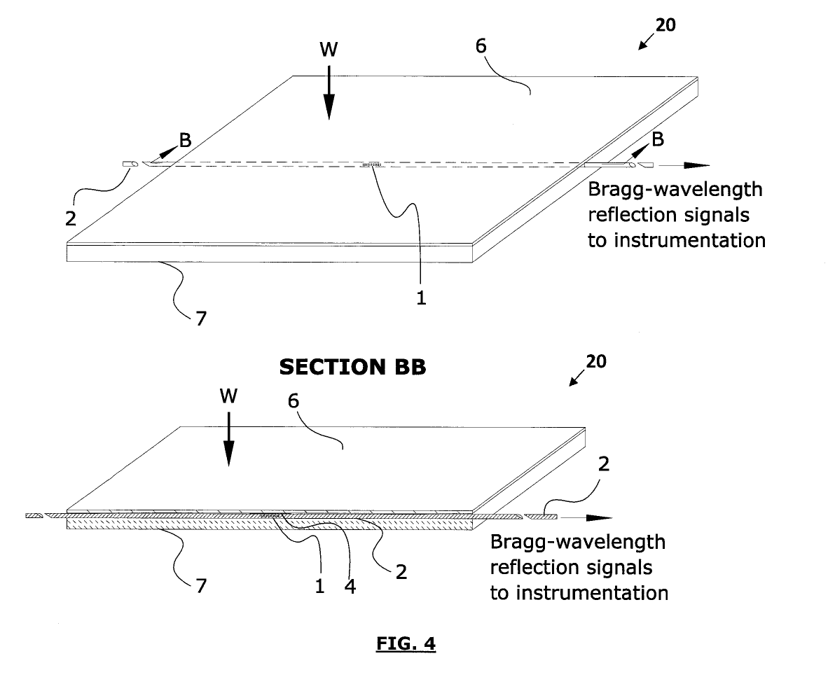

The simply supported beam model of FIG. 3 is generally not practical as a security mat sensing device. It needs to be too thick and too heavy to support a substantial weight W, it is too narrow to support typical foot traffic, object, or vehicle loads, and would need to be too rigid to be rolled up for simple transportation to and installation at the user site. However, the same general principles apply for a practical mat as for a beam, albeit in a more mathematically complex way. In FIG. 4, a wide and thin membrane 6—for example, a meter or less wide and no more than a few millimeters thick—replaces beam 3 of FIG. 3. The membrane material can be chosen to have sufficient modulus and thickness to transmit strains from incident loads anywhere on the mat to one or more of the fiber Bragg gratings so as to cause readily measurable shifts in the reflected Bragg wavelengths of one or more fiber Bragg gratings. Examples of membrane materials are as follows:
Polymer membrane—A suitable example material of a polymer membrane is polyethylene terephthalate (Mylar), which has been used in a successfully tested prototype of the fiber optic security mat sensing device. An appropriately selected polymer membrane has the advantages of potentially low cost, adequate rigidity for strain distribution yet sufficient flexibility for device roll-up, resistance to moisture and chemicals, and light weight. A possible disadvantage of a polymer membrane can be the potential susceptibility to optical fiber cut damage, whether deliberate or unintentional (such as when a sharp-edged object is placed on the mat).
Metallic membrane—Examples of metallic membranes are thin steel or stainless steel, preferably tempered (i.e. spring steel or spring stainless steel). A key advantage of a metallic membrane is resistance to cut damage, whether deliberate or unintentional (such as when a sharp-edged object is placed on the mat). Tempering of the metallic membrane material also results in resistance to plastic deformation.
Composite-material membrane—Examples of potential composite materials for the membrane include glass-fiber, Kevlar fiber, or graphite-fiber filled polymers, or, alternatively laminates of plain polymers with cut-resistant layers of Kevlar or other cut-resistant material. Such membrane structures have the potential to provide the flexibility, resistance to moisture and chemicals, and light weight of plain polymers while possessing greater resistance to cut damage.

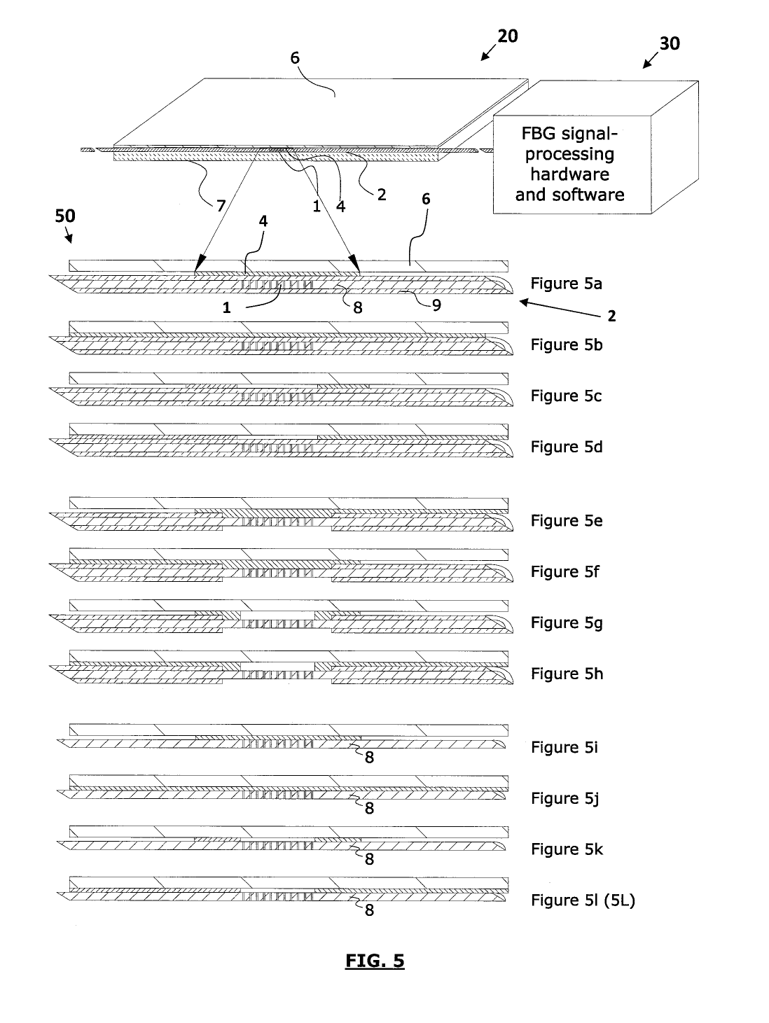

With continuing reference to FIG. 4, the optical fiber 2 including at least one fiber Bragg grating 1 can be bonded to the membrane 6, to form a membrane strain sensor assembly 50, as shown in FIG. 5. While only one fiber Bragg grating 1 is shown, multiple fiber Bragg gratings can be incorporated to enhance sensitivity for detection of persons, objects, or vehicles—represented by load or weight W—incident on at any part of the device. (Note that FIG. 6 shows just a few examples of multiple-grating patterns in a security mat sensing device 20.) Although fiber Bragg gratings 1 are shown as the optical sensors or strain-sensing elements in FIG. 4, distributed fiber optic sensors, specifically a plain or standard optical fiber without fiber Bragg gratings, can be used interchangeably as discussed subsequently for FIGS. 12a and 12b. Compliant layer 7 in FIG. 4 replaces the simple supports 5 of FIG. 3, so as to provide a uniform support over the entire membrane for all foreseeable loads W while allowing enough deflections at any point on membrane 6 to be detectable as strains at fiber Bragg grating 1. Compliant layer 7 can be made from a variety of materials such as closed cell elastomer or plastic sponge or foam, soft rubber such as low durometer neoprene, a gel-filled rubber or plastic envelope, an elastomeric composite, or similar compliant material.

With continuing reference to FIG. 4, the fiber Bragg grating 1 is connected to FBG signal processing hardware and software 30. The FBG signal processing hardware and software 30 represents all of the components needed to input light to fiber Bragg gratings 1, convert grating reflections into meaningful data, and process the information to result in needed signals to the user. The signal processing hardware and software 30 may include:
One or more instruments or instrument combinations that can translate shifts of fiber Bragg grating characteristic Bragg wavelengths into data signals—devices and combinations that are well known in the fiber-optics art.
A signal processing device or devices, such as one or more computers, that, with suitable software and/or firmware, can use data signals to record and analyze security mat events.
Software and/or firmware for the signal processing device or devices that can analyze the fiber Bragg grating wavelength shifts and discriminate between the presence of innocuous and potentially adverse loads incident on the novel sensing device, trigger alarms and notifications, optionally determine the speed and direction of travel of moving loads, optionally estimate the magnitude of loads, and optionally trigger other security events well known in the art, such as the focusing of video cameras to the locations where loads have been detected.
All the necessary interface circuitry to interface the fiber optic security mat system to the user systems.

With reference now to FIG. 5, the fiber Bragg grating 1 and optical fiber 2 are shown in more detail. In FIGS. 5a-5h, a coated fiber 8 is further enclosed in a buffer material 9, typically made from polymers but alternatively from other materials. In FIGS. 5i-5l, the coated fiber 8 is unbuffered. The optical fiber 2 including at least one fiber Bragg grating 1 can be bonded to the membrane 6 with bonding agent 4, to form a membrane strain sensor assembly 50, in a variety of ways:
FIG. 5a shows local bonding of the buffered optical fiber 2 to membrane 6 with bonding agent 4 both at the grating and adjacent to the grating. According to the following embodiments, this can be the simplest construction.
FIG. 5b shows both local and extended bonding of the buffered fiber with bonding agent 4. This approach potentially provides extended reliability and better coupling to membrane 6.
FIG. 5c shows local bonding of the buffered fiber only adjacent to the grating. This approach reduces the potential for uneven transfer of strain across the length of the grating, due to non-uniform bonding (effectively creating non-uniform unequal stretching of the Bragg reflection planes of the grating under strain).
FIG. 5d shows extended bonding of the buffered fiber, but no local bonding, thus providing the advantages of the constructions of both FIGS. 5b and 5c.
FIGS. 5e through 5h show the same construction methods of FIGS. 5a through 5d, except that the fiber at and around the fiber Bragg grating has been stripped down to the primary coating of the fiber (such as acrylate or polyimide polymers). Bonding the stripped fiber potentially provides greater sensitivity, because there is no buffer that can slip on the fiber and no extra material that needs to be stretched.
FIGS. 5i through 5l (5L) show the same construction methods of FIGS. 5a through 5d, except unbuffered fiber Bragg gratings and optical fibers (the glass fibers plus their thin polymeric or metallic coatings) are used at all fiber locations in the fiber optic security mat sensing device 20. The embodiments in these figures potentially have the lowest cost and are the most sensitive option when using unbuffered fiber (without stripping) with the optical connectors for the fibers integrated into the device.

FIG. 6 shows several different ways that a plurality of the fiber Bragg gratings may be fastened to membrane 6 in a variety of patterns and densities, dependent on the detection sensitivity required, primary traffic direction anticipated, and materials used. The tiny groups of slanted lines in FIG. 6 represent fiber Bragg gratings 1. The mat may incorporate a single fiber or a plurality of fibers. More gratings will enable greater detection sensitivity and better resolution of the following: person, object, or vehicle locations, weight, movement direction, movement speed, and number of objects or persons.

The different patterns, the number of fiber Bragg gratings, and the number of fibers shown represent only a few of an almost infinite amount of variations, as will be clear to anyone skilled in the art. The examples shown in no way limit the many different configurations of the present invention.

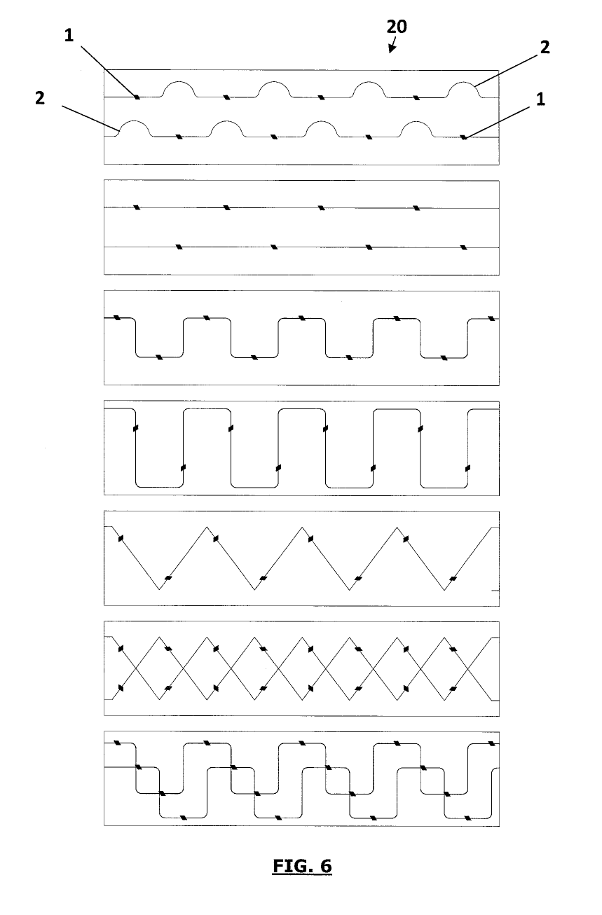

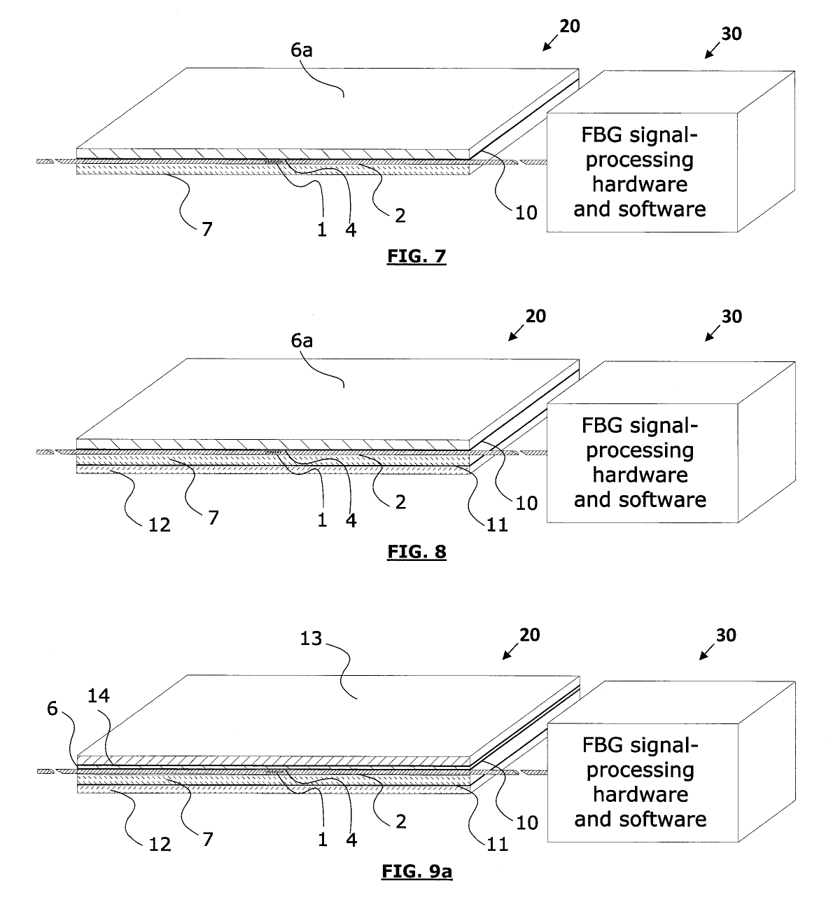

FIG. 7 shows a cross section according to one embodiment, in which the top of the combined strain-distributing membrane and mat layer 6a also functions as the mat surface on which people, objects, and vehicles are incident. In some embodiments, the combined strain-distributing membrane and mat layer 6a is thicker than the strain-distributing membrane 6. The optical fiber 2 including at least one fiber Bragg grating 1 can be bonded to the combined strain-distributing membrane and mat layer 6a, to form a membrane strain sensor assembly. The combined strain-distributing membrane and mat layer 6a and the bonded fiber Bragg gratings 1 function as both the mat layer and the membrane strain sensor assembly. The top surface of combined strain-distributing membrane and mat layer 6a may have relief patterns (such as ribs or dots) to increase pedestrian traction. Bonding agent 10 can bond this membrane strain sensor assembly to the compliant layer 7 continuously or discontinuously (such as with dots or stripes of bonding agent).

In some embodiments, the combined strain-distributing membrane and mat layer 6a is made from a polymer (plastic, elastomer, or soft composite) of sufficient modulus and thickness to transmit strains from incident loads anywhere on its upper surface to one or more of fiber Bragg gratings on its lower surface, so as to cause readily measurable shifts in fiber Bragg grating reflected Bragg wavelengths. The combined strain-distributing membrane and mat layer 6a must not be too thin as to transmit strain inadequately or be damaged easily and not too thick as flex insufficiently.

According to some embodiments, the geometry and composition of the combined strain-distributing membrane and mat layer 6a must meet the requirements of flame resistance (in some cases), good traction, puncture and environmental-damage resistance, stable mechanical properties, rapidly-responding resilience, low hysteresis, and preferably low thermal coefficient of expansion to minimize thermally induced strains at the one or more fiber Bragg gratings.

FIG. 8 shows the cross-section of an alternative embodiment of the device 20 shown in FIG. 7, in which a protective bottom layer 12 is added below the compliant layer 7. This embodiment includes additional adhesive 11 and a protective bottom layer 12 on the bottom of the assembly that protects the upper layers from damage and provides a surface that resists sliding or can be bonded to a variety of substrates. This protective bottom layer 12 can be made of a polymer, metal or composite material. Bonding agent 11 bonds the compliant layer 7 to the protective bottom layer 12 continuously or discontinuously (such as with dots or stripes of bonding agent).

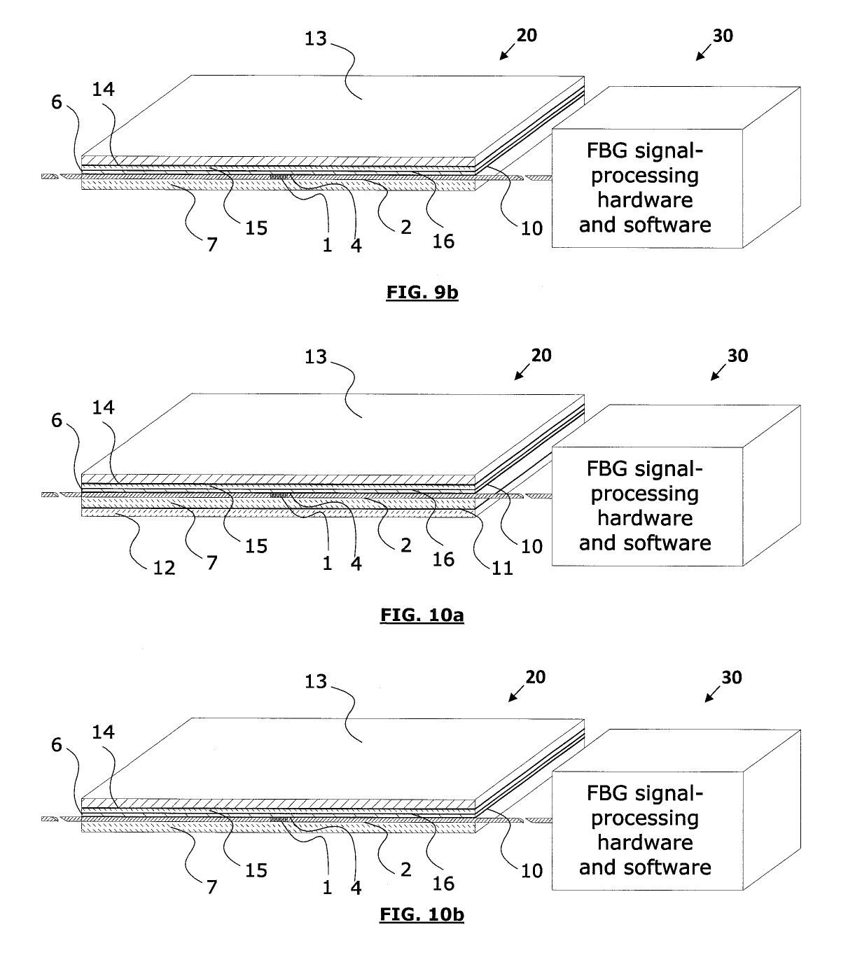

FIG. 9a shows the cross-section of an alternative embodiment of the device 20 shown in FIG. 8. This embodiment includes a separate mat layer 13 and additional bonding agent 14. The separate mat layer 13 allows at least partial independence of the mat layer 13 properties from membrane 6 properties, which can potentially allow a mat layer 13 with greater ruggedness. Although coupled to the membrane layer 6 by bonding agent 14, the mat layer 13 material can be chosen more independently and may be more easily optimized, for example, for optimal cost, traction, wear, and flame resistance.

FIG. 9b shows the cross-section of an alternative embodiment of the device 20 described in FIG. 9a. This embodiment eliminates bottom layer 12 and bonding agent 11 and makes the compliant layer 7 serve as the bottom layer as well. This approach is reasonable and cost-saving when the compliant layer 7 is chosen appropriately for compliance, toughness, slip resistance on the bottom surface, and bondability to a substrate. A soft rubber is likely a better a better choice for this configuration than a foam or sponge material.

With continuing reference to FIGS. 9a and 9b, the fiber Bragg gratings 1 can be bonded to the top of membrane 6 instead of on the bottom, most commonly resulting in a compressive strains at the grating sites. Pre-tensioning of the fiber Bragg grating 1 is advisable when bonding the fiber Bragg grating 1 to the top of membrane 6. By contrast, pre-tensioning of the fiber Bragg grating 1 is less important or in some cases unnecessary when bonding the fiber Bragg grating 1 to the bottom of the membrane 6. In some embodiments, a fiber Bragg grating 1 bonded to the bottom of the membrane 6 is better protected from damage, due to the added layer between the fiber Bragg grating 1 and the person, object, or vehicle incident on the surface of the mat. This added protection is especially true when the membrane 6 is made from metallic or cut-resistant composite material.

FIG. 10a shows the cross-section of an alternative embodiment of the device 20 shown in FIG. 9a. This embodiment adds a compliant layer 15 bonded between the mat layer 13 and the membrane layer 6 by additional bonding agent 16. This additional compliant layer 15 at least partially decouples the properties of mat layer 13 from membrane layer 6, thereby allowing the mat layer 13 material to be chosen even more independently than for the embodiment shown in FIG. 9a.

FIG. 10b shows the cross-section of an alternative embodiment of the device 20 described in FIG. 10a. This embodiment eliminates bottom layer 12 and bonding agent 11 and makes the compliant layer 7 serve as the bottom layer as well. This approach is reasonable and cost-saving when the compliant layer 7 is chosen appropriately for compliance, toughness, slip resistance on the bottom surface, and bondability to a substrate. A soft rubber is likely a better a better choice for this configuration than a foam or sponge material.

With continuing reference to FIGS. 10a and 10b, the fiber Bragg gratings 1 can be bonded to the top of the membrane 6 instead of on the bottom, most commonly resulting in compressive strains at the grating sites, as discussed for the configurations in FIGS. 9a and 9b.

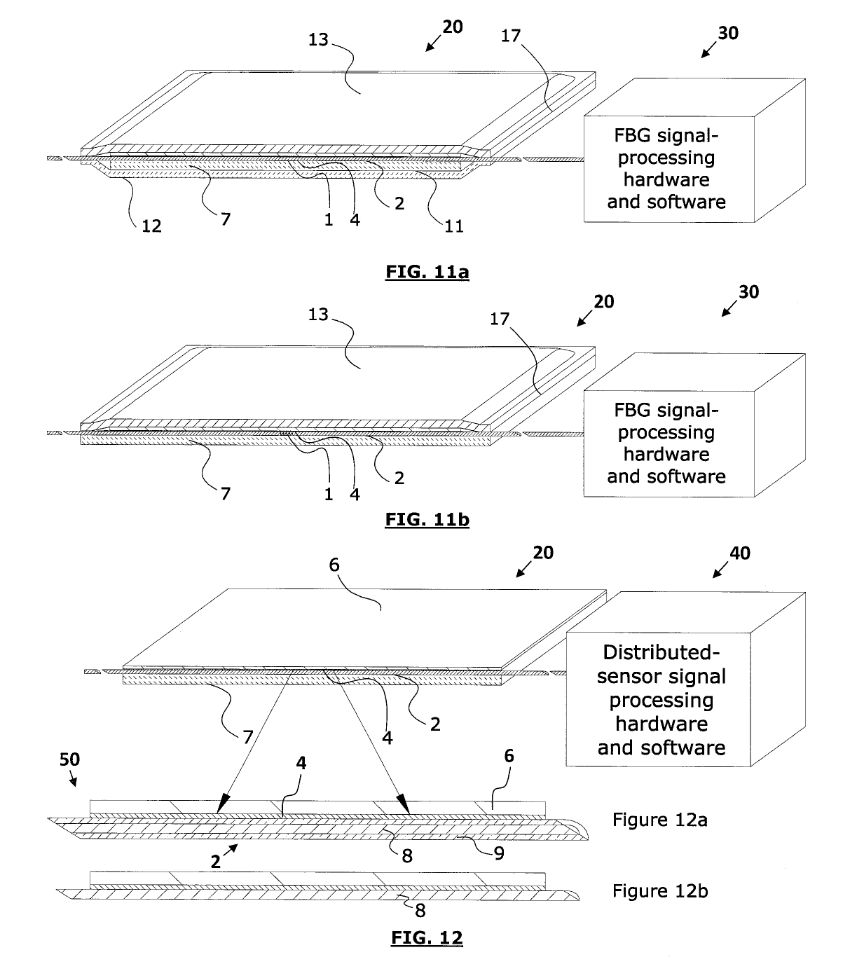

FIG. 11a shows the cross-section of a four-layer embodiment in which the fiber Bragg grating-containing membrane layer 6 and the compliant layer 7 are unbonded to any other layer. Further, the mat layer 13 and the bottom layer 12, which are longer and wider than the membrane layer 6 and compliant layer 7, are sealed together at the edges 17, thereby encapsulating the membrane layer 6 and compliant layer 7. This four-layer construction has several benefits.

A first benefit is the absence of interlayer bonding decouples the membrane strain sensor assembly from the physical properties of the mat layer 13 and the bottom layer 12, thereby minimizing the effects of mat differential thermal expansion on device performance and eliminating the potential for shear de-bonding. Further, it minimizes potential hysteresis by decoupling strains in the membrane layer from potentially slow-recovering deformation in the force-application layer (mat). Therefore, mat material and configuration selection then can be more focused on economy, meeting safety requirements, traction, ruggedness, esthetics, etc.

A second benefit is the absence of interlayer bonding reduces the hazards and costs of applying substantial quantities of bonding agents. It also avoids potential solvent degradation of device layers if a solvent-containing bonding agent is used and it likewise eliminates potential bonding agent aging issues.

A third benefit is the encapsulation shields the internal layers, and particularly the fiber Bragg gratings, from contamination from dirt, moisture, and chemicals.

FIG. 11b is the cross-section of an alternative embodiment of the device 20 shown in FIG. 11a. This embodiment eliminates bottom layer 12 and bonding agent 11, thereby making the compliant layer 7 serve as the bottom layer as well. This approach is reasonable and cost-saving when the compliant layer 7 is chosen appropriately for compliance, toughness, slip resistance on the bottom surface, and bondability to a substrate. A soft rubber is likely a better a better choice for this configuration than a foam or sponge material.

With continuing reference to the configuration of FIGS. 11a and 11b, the unbonded middle layer(s) could potentially result in a slightly less robust device construction, due to a greater allowance for the mat layer to bulge or buckle. Furthermore, full encapsulation could potentially result in a potential for the device to balloon or expand due to thermal expansion of residual gas between the layers of the device in a warm environment. The following approaches (not shown in FIG. 10a) could mitigate or eliminate such concerns:
1. A first approach in manufacturing of the device can include the mechanical evacuation of air space between the layers in a manner similar to the evacuation of air space in a plastic food storage bag. The result can be a very minimal internal gas volume, which reduces the potential for ballooning of the security mat sensing device due to thermal expansion of residual inter-layer gas, thereby resulting in a flatter device.
2. Alternatively to the first approach above, venting of the air space between the layers with a microporous hydrophobic membrane—such as a Gore-Tex membrane—will allow breathing of the device. Inclusion of such venting can minimize the potential for a ballooning of the security mat sensing device due to thermal expansion of residual gas between the layers of the device. The vent membrane's hydrophobic nature and fine pore size avoids the ingress of water, and its fine pore size avoids the ingress of dirt.
3. To avoid bulging or buckling between the layers, frictional coatings—for example, rubbery anti-slip coatings such as applied to the undersides of carpets—can be applied to the inner surfaces. The frictional coating can be applied to just one surface of each pair of interfacing surfaces or to both interfacing surfaces.

With continuing reference to FIGS. 11a and 11b, the fiber Bragg gratings 1 can be bonded to the top of the membrane 6 instead of on the bottom, most commonly resulting in compressive strains at the grating sites, as discussed for the configuration in FIGS. 9a and 9b.

The following principles shown and described for FIGS. 11a and 11b can likewise be applied to the embodiments described in FIGS. 8 through 10b:
a. Encapsulation;
b. Non-interbonding of layers within the capsule between the edge sealed top and bottom layers;
c. Evacuation or hydrophobic venting of the encapsulated layers to prevent ballooning; and
d. Anti-bulging/buckling frictional coatings between layers

With reference to all the FIGURES, an alternative strain sensing technology, namely fiber optic distributed strain sensing, can be interchangeably incorporated into all embodiments of the invention. Specifically, fiber optic distributed strain sensing can be used instead of fiber Bragg grating strain sensing. Fiber optic distributed strain sensing uses distributed-sensor signal processing hardware 40 and plain optical fiber 2 as the sensing medium, instead of fiber Bragg gratings 1.

Fiber optic distributed strain sensing typically involves use of just the optical fiber 2 itself as a continuous, integral string of sensors; no fiber Bragg gratings 1 or other optical sensors or discrete measurement devices are incorporated into or installed onto the optical fiber. The optical fiber 2 itself is the optical sensor. Special signal-processing hardware and software and/or firmware 40 scans an entire length of fiber for local strain-caused property modifications. A variety of approaches can be used for this purpose. Distributed strain sensing can be based on

Rayleigh scattering, Raman scattering, or Brillouin scattering. For example, in one class of distributed sensing technologies, the frequency shifts of Brillouin-scattering peaks are monitored as a function of strain over a length of fiber.

Fiber optic distributed strain sensing techniques use just the optical fiber 2 as an optical sensor and generally do not include other discrete sensing devices, such as fiber Bragg gratings 1. Therefore, at least in large systems, the cost per/detection point in fiber optic security mat devices 20 can be lower than in a fiber Bragg grating based device. Typical distributed strain measurements can require a minimum length of locally strained fiber—as much as a meter for quantitatively accurate strain measurements. However, for semi-quantitative detection of persons, objects, or vehicles in a fiber optic security mat device, smaller strained lengths are sufficient.

Referring now to FIG. 12a, the optical fiber 2 includes a buffer 9 surrounding a coated optical fiber 8. The optical fiber 2 can be bonded to the membrane layer 6 in the same manner as shown and described in FIG. 5b. The buffered fiber 2 used for distributed sensing is incorporated into the fiber optic security mat device 20 in the same way as a fiber-Bragg-grating-containing fiber. According to some embodiments, because the strain is measured over a substantial length of fiber and not at a discrete point, the fiber 2 can be fully bonded to the membrane 6 with bonding agent 4. The localized-only bonding approaches shown in some of the Figures may not apply to distributed sensing. The optical fiber 2 can be bonded to the membrane 6 to form a membrane strain sensor assembly 50.

Referring now to FIG. 12b, the optical fiber 2 includes a plain (unbuffered) coated optical fiber 8. The optical fiber 2 can be bonded to the membrane layer 6 in the same way as shown and described in FIG. 5j. The unbuffered fiber 2 used for distributed sensing is incorporated into the fiber optic security mat device 20 in the same way as a fiber-Bragg-grating-containing fiber. According to some embodiments, because the strain is measured over a substantial length of fiber and not at a discrete point, the fiber 2 can be fully bonded to the membrane 6. The localized-only bonding approaches shown in some of the Figures may not apply to distributed sensing.

With continuing reference to FIGS. 12a and 12b, when the invention includes a separate strain-distributing membrane 6, the optical fiber 2 can be bonded to the top of the membrane 6 instead of on the bottom, most commonly resulting in compressive strains at the grating sites, as discussed for the fiber Bragg grating configuration in FIGS. 9a and 9b.

With reference to FIGS. 4 through 12b, a standard optical fiber 2, analyzed with distributed-sensor signal processing hardware and software and/or firmware 40 (instead of fiber Bragg grating signal processing hardware and software and/or firmware 30), can be interchanged in all of the configurations and embodiments shown and described. The distributed sensor signal processing hardware and software 40 represents all of the components needed to input light into the optical fiber, acquire the output, convert the output into meaningful data, and process and report the data to a user. According to some embodiments, the patterns of the optical fiber in the distributed-sensor equipped fiber optic security mat device 20 can be more dense than the patterns shown in FIG. 6.

Many applications and uses exist for this invention including, but not limited to, the applications described below. In addition, with appropriate software and/or firmware programming, the present invention can be used to determine the direction and speed of movement across or along the length of the mat, especially if the density of fiber Bragg gratings or distributed sensor fibers is high. Therefore, for example, the invention can determine pedestrian or vehicle movement direction and speed into or out of an entryway or sensitive area. The invention can also estimate the weight of a person, object, or vehicle.

For the transportation industry, the invention can be used for detecting, reporting, alarming, taking automatic action as follows:
The invention can detect the presence of unauthorized objects or persons next to a railway or subway track, for example, on a rail platform. An unauthorized person could be a person who has fallen from the passenger platform or otherwise stepped near the track and could be injured or killed by the train. An unauthorized object could be a bomb intended to harm passengers or equipment. Alternatively, an advertently placed or inadvertently fallen object could damage rail equipment or disrupt rail traffic. With the inclusion of suitable software and/or firmware, the invention can estimate the weight of the person or object, thereby avoiding false alarms, such as could be triggered by a small animal next to the track. It can also indicate the location of the person or object and focus a video camera on this location to identify person or object. Further, it can trigger automatic shutdown of the train or subway. Further, it can remotely notify law enforcement officials via a variety of communications such as phone, internet, and satellite.
The invention can detect the unauthorized entry of a railway or subway tunnel.
The invention can detect the intrusion of an unauthorized or dangerous pedestrian zone, including the presence of a person or object at the edge of a rail or subway platform.
The invention can detect the unauthorized entry of any other restricted zone, including loading and unloading zones, money-handling areas such as ticket booths, and hazardous high-voltage electrical areas.

For a variety of industries, the invention can detect and act upon incidences of security tailgating. During a security tailgating events the following occur. An authorized person uses a key, swipes a keycard, punches a security code, completes fingerprint or iris detection, etc. Then, just as the restricted entry door or gate opens, an unauthorized person (or multiple persons) attempts to enter the restricted area by quickly following on the heels of the authorized person before the restricted entry door or gate closes. Such unauthorized entry not only compromises the protected area but also potentially compromises the personal safety of the authorized person. Using appropriate system software and/or firmware, the invention can distinguish the presence and locations of multiple persons, generate alarms, direct the recording of videos of the persons, and remotely notify law enforcement personnel. In large scale installations involving dozens of secured rooms and safe zones spread over a large area, the fiber-optic nature of the invention allows a large number of secured entrances to readily be monitored at a centralized security station thousands of feet away. Only one small EMI-proof single optical fiber is required per mat, although multiple fibers can be used, to transmit the detection signals; in some cases several mats can be connected through a single fiber cable, especially if advanced fiber Bragg grating identification techniques or distributed fiber optic sensing techniques are employed.

For example, the invention provides enhanced tailgating security in the following applications:
The invention can detect single-door tailgating detection at a fraction of the cost of optical turnstiles.
The invention can detect man-trap tailgating. A man-trap in modern physical security protocols refers to a small space having two sets of interlocking doors or gates such that the first set of doors must close before the second set opens. Identification may be required for each door, and possibly different protection measures may be used for each door. For example, a key may open the first door, but a personal identification number entered on a number pad opens the second. Other methods of opening doors include proximity cards or biometric devices such as fingerprint readers or iris recognition scans. Man-traps may be configured so that when an alarm is activated, all doors lock and trap the suspect between the doors in the “dead-space” or lock just one door to deny access to a secure space such as a data center or research lab. Man-traps make it difficult to force entry by breaking down a single door, allow time to evaluate the person before entry through the second door or gate, and ideally allow only one person to enter at a time. If more than one person tries to enter at the same time, the anti-tailgating features of the invention avoid double entry by automatically implementing appropriate security measures.
Tailgate system with door control. The invention can be used to combine the functions of a local door alarm and a tailgate alarm with door lock control into a single integrated door monitoring and control system.
Vault tailgate detection system. The invention can be used to protect bank vaults and can be designed to provide multiple detection levels to distinguish pedestrian and vehicle traffic.
Two-man rule control system. The invention can be used to control entry and exit of personnel into and from sensitive areas where a minimum of two people is required.

The invention can be used to survey the density and speed of foot traffic in a particular area. From a security standpoint, the speed evaluation capability can potentially be detect and locate a running individual following commission of a crime. From a marketing standpoint, a store, shopping center, or mall can use the invention to survey shopper movement patterns.

The invention can be used as part of a perimeter security system in front of or around a controlled access areas. Examples include the areas in front of or around:
Dangerous machinery or equipment.
Restricted-access and/or tamper-risk control systems, such as power grid controls, chemical process controls, manufacturing line controls, and nuclear reactor controls.
Contamination-sensitive regions.
Buildings or building complexes. If a building or building complex is surrounded by hard-surface walkways, the invention can be used directly as the contact surface. In other situations, the mat layer can be partially or fully made of artificial grass, can be partially or fully overlaid with artificial grass, or can be partially or fully overlaid with mulch or other camouflaging material.
Hazmat storage areas.

The invention can be used to protect access to or detect excess personnel in clean rooms, such as are common in pharmaceutical and semiconductor manufacturing facilities.

A business can use the system to detect unusual weight in exit and entry passage areas, alerting officials to the possibility of external-agent theft or employee pilfering.

A nursing home or other medical facility can use the system to detect unusual static weight distribution on a walkway, suggesting that a patient may have fallen.

A facility could use the invention for crowd control, especially in a maximum-legal-capacity room or building. It could be used to automatically restrict access to the facility when the difference between the number of people entering and exiting the facility exceeds a preset threshold, and then automatically restore access when the difference between the number of people entering and exiting the facility falls below a preset threshold.

A mental health facility or dementia or Alzheimer's disease care facility can use the invention to detect and track wandering patients, thereby protecting them from harm to themselves or others.

A wide variety of facilities can potentially use the invention to estimate weight, for example, to use it effectively as a wide-area load cell. A few non-limiting examples include: inside grain silos, under liquid storage tanks, on cargo docks, and under aircraft luggage storage areas.

In another application of the present invention, the fiber optic mat can be used as a fire detector. The optical fiber and fiber Bragg grating temperature coefficient is large relative to the strain coefficient. If the security mat is used only for transient strain-event detection, the temperature effect is substantially irrelevant because detection of a transient strain event occurs quickly—much too rapid for ambient temperature to influence the outcome. However, the security mat can double as a fire-detection device, so the normally undesirable temperature response is extremely valuable. The fire-detection temperature-rise signature is much different from the transient strain-event detection signature, so software can detect a fire near an entrance/exit and alert appropriate personnel.

As will be apparent after reviewing the preceding specification, this list of applications and uses represents only a sampling of the potential applications and uses for this invention.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A sensing device comprising:
a first layer including a first surface for supporting an associated load, wherein the first layer transmits a strain to a second surface due to the associated load location on the first surface;
a second layer formed of a compliant material, wherein the second layer provides substantially uniform support to the first layer and deflects due to the associated load; and
an optical sensor positioned between the first and second layers, wherein the optical sensor senses the strain due to the associated load.

2. The sensing device of claim 1, wherein the first layer comprises one of a polymer membrane, a metallic membrane, or a composite membrane.

3. The sensing device of claim 1, wherein the second layer comprises one of a closed cell elastomer, a plastic sponge, a closed cell foam, a soft rubber, a gel-filled rubber or plastic envelope, or an elastomeric composite.

4. The sensing device of claim 1, wherein the second layer further comprises a bottom surface that resists sliding.

5. The sensing device of claim 1, wherein the first layer comprises a top layer including the first surface and formed of a wear-resistant material, and wherein the first layer further comprises a separate middle layer including the second surface and formed of a material having sufficient modulus to transmit strains from the associated load to the optical sensor.

6. The sensing device of claim 5, wherein the top layer comprises a plastic mat.

7. The sensing device of claim 1, wherein the second layer comprises a middle layer formed of the compliant material which deflects due to the associated load, and wherein the second layer further comprises a separate bottom layer providing protection to the other layers.

8. The sensing device of claim 1 further comprising:
a microporous hydrophobic membrane operatively connected to the volume between the layers which facilitates venting of the air between the layers due to thermal expansion.

9. The sensing device of claim 1, wherein the optical sensor comprises an optical fiber including at least one fiber Bragg grating operatively connected to an associated fiber Bragg grating signal processing system.

10. The sensing device of claim 1, wherein the optical sensor comprises an optical fiber operatively connected to an associated distributed sensing signal processing system.

11. A sensing device comprising:
a first layer including a top surface for supporting an associated load, the top surface formed of a flexible and wear-resistant material;
a second layer including a membrane with sufficient modulus to transmit strains from the associated load to an optical sensor operatively connected to the second layer; and
a third layer formed of a compliant material having a resilience which allows the second layer to flex and recover due to the associated load;
wherein an outside edge of the third layer is operatively attached to an outside edge of the first layer substantially encapsulating the second layer, and wherein the second layer is able to move relative to the first and third layers.

12. The sensing device of claim 11 further comprising:
a microporous hydrophobic membrane operatively connected to the volume between the layers which facilitates venting of the air between the layers due to thermal expansion.

13. The sensing device of claim 11, wherein the second layer comprises a frictional coating on surfaces adjacent the first and third layers.

14. The sensing device of claim 11 further comprising:
an additional layer positioned between the first and second layers, the additional layer formed of a compliant material which deflects due to the associated load.

15. The sensing device of claim 11 further comprising:
an additional layer positioned beneath the third layer to provide protection to the upper layers.

16. The sensing device of claim 11, wherein the optical sensor comprises an optical fiber including at least one fiber Bragg grating operatively connected to an associated fiber Bragg grating signal processing system.

17. The sensing device of claim 11, wherein the optical sensor comprises an optical fiber operatively connected to an associated distributed sensing signal processing system.

18. A method of assembling a strain sensing device comprising the steps of:
attaching an optical fiber to a middle layer so that any strain created by an associated load and experienced by the first layer is transmitted to the optical fiber;
attaching a top layer to a bottom layer along an outside edge substantially encapsulating the first layer between the second and third layers;
connecting the optical fiber to an associated signal processing system for measuring the strain created by the associated load.

19. The method of claim 18 further comprising the steps of:
evacuation of at least a portion of any volume between the layers to minimize any air between the layers and thereby preventing ballooning effects from thermal expansion of the air.

20. The method of claim 18 further comprising the steps of:
evacuating at least a portion of any air located between the top and bottom layers before substantially sealing the middle layer between the top and bottom layers.

21. The method of claim 18 further comprising the steps of:
applying a frictional coating between the top and middle layers and between the middle and bottom layers before substantially sealing the middle layer between the top and bottom layers.

22. The method of claim 18 further comprising the steps of:
inserting an additional layer between the top and bottom layers before substantially sealing the additional and middle layers between the top and bottom layers.
